(19) United States
(12) Patent Application Publication
(10) Pub. No.: US 2013/0087522 A1
(43) Pub. Date: Apr. 11, 2013

(54) METHOD FOR LOAD TORQUE LIMITATION OF A WORKING VEHICLE COMPRISING A JIB

(71) Applicants: Dieter Jung, Malsch (DE); Hans Braun, Karlsruhe (DE); Petra Kramer, Bietigheim (DE); Johan Regin, Karlsruhe (DE)

(72) Inventors: Dieter Jung, Malsch (DE); Hans Braun, Karlsruhe (DE); Petra Kramer, Bietigheim (DE); Johan Regin, Karlsruhe (DE)

(21) Appl. No.: 13/579,788

(22) PCT Filed: Jun. 20, 2011
(86) PCT No.: PCT/EP2011/003040

§ 371 Date: Nov. 26, 2012

(30) Foreign Application Priority Data
Jun. 24, 2010 (DE) 10 2010 025 022.8

(51) Int. Cl. B66C 23/90

(52) U.S. Cl. CPC B66C 23/90
USPC 212/278

(57) ABSTRACT

The invention relates to a method for the load torque limitation of a work vehicle comprising a jib, in particular a mobile crane comprising a multi-part, preferably hydraulically movable jib or telescoping jib, wherein on the basis of captured operating parameters of the work vehicle such as pressure, angle, length, configuration and the like from at least one multi-dimensional characteristic map a load value is determined and compared to a load limit value which is determined depending upon the captured operating parameters, wherein a warning is issued and/or the operation of the work vehicle is automatically interrupted when the actual load value exceeds the load limit value, wherein depending upon the captured operating parameters a value for a potential total energy of the work vehicle is calculated, taking into account the configuration of the work vehicle, and the unknown load value is determined on the basis of said value.

The invention relates to a method of torque-load limitation of a working vehicle having a boom, in particular a mobile crane having a multipart boom, preferably hydraulically movable, according to the features of the introductory clause of claim 1.

Methods of torque-load limitation of working vehicles are known in principle, with two different methods from the prior art being described below.

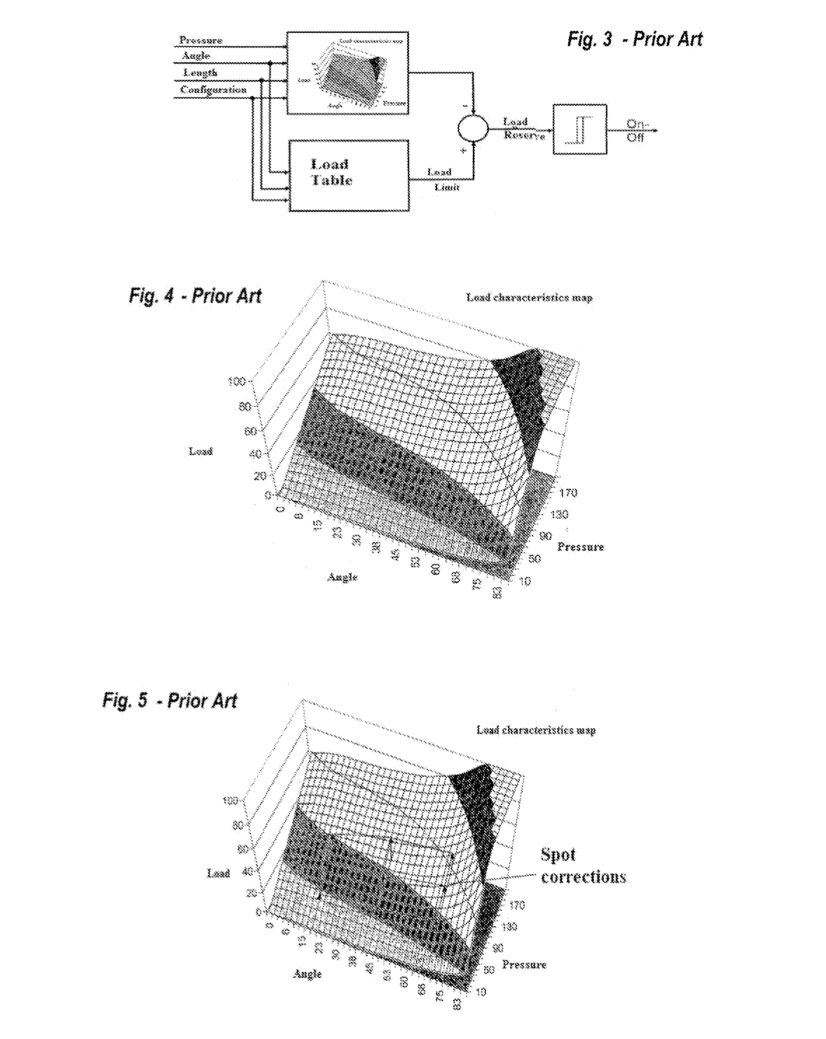

A first method is illustrated in FIGS. 3 to 5. Operating parameters of the working vehicle such as pressure (for example in the working cylinders for raising and lowering a boom), angle (of the boom), length (of the boom in particular) and additional parameters of the working vehicle (for example the number of telescoping elements of a telescoping boom) are detected and are supplied, first to a multidimensional characteristics map and second to a load table with load-limit values. First, from the operating parameters thus detected, a prevailing load value is determined that should correspond to the actual load attached (in reality, it should correspond, but as a rule, it does not actually correspond). Second, a load-limit value is determined from the load table. The load value obtained from the characteristics map is compared with the load-limit value (optionally taking into account a predetermined load reserve), so that then when the actual load value from the characteristics map exceeds the load-limit value from the load table, a warning is issued to the operator of the working vehicle and/or operation of the working vehicle is necessarily interrupted because it is known that this is a case of a safety-critical condition of the working vehicle (for example there is the possibility of falling over). FIG. 3 shows a schematic device for performing the procedure described above, such that a three-dimensional load characteristics field is shown in FIG. 4, and more than one such load characteristics field may also be present. Since the points in this characteristic field are generated as examples by measurements prior to starting operation of the working vehicle, a precise load value cannot always be derived from the load value in FIG. 4 as a function of the operating parameters detected (such as angle, pressure and the like). It is therefore necessary to perform spot corrections, as indicated in FIG. 5. However, performing such spot corrections is time-consuming and also uses up a great deal of computation power and storage space, so that not all operating parameters lead directly to the desired load value. Furthermore, because of the spot corrections, it is necessary to have a load reserve of a suitable dimension, so unfortunately it happens very often in practice that a warning is issued and operation of the working vehicle is necessarily interrupted although there is a load that would not necessitate this. One should consider that the individual points in the load-characteristics map according to FIG. 2 are interpreted very narrowly, but this necessitates a disproportionately great effort in compiling the load-characteristics map because different combinations of the operating parameters can always be set in multiple experimental series and as a function of the configuration of the working vehicle, and the load must always be determined. This is not feasible for the crane manufacturer for reasons of procedural economy.

One alternative to the method already described is disclosed in DE 100 23 418 [U.S. Pat. No. 6,587,795], where a method of overload protection of a mobile crane is disclosed, characterized by the following steps:

Geometric data obtained from component is stored in a memory,

The desired equipment status is selected in a selection device,

A physical simulation model is compiled from the selected data in a control computer,

Real measured data from force and position sensors is mounted on the crane are entered,

The geometric data, center of gravity data and forces are calculated first and then the shutdown values are calculated,

The crane is optionally shut down on reaching the shutdown values.

A method of overload protection is created by this method of overload protection, which is known from DE 100 23 418. With this method, the prevailing shutdown values can be ascertained quickly and accurately, even for a plurality of possible equipment states. Although this reduces the effort for compiling the load-characteristics map and the subsequent computation and storage complexity in interpolation, it is still only possible to accurately calculate the load actually attached, which has a negative effect, and in particular tolerances or changes in the crane components, which were not present at the creation of the load-characteristics map or were unknown at that time are still not taken into account.

The object of the present invention is therefore to improve upon a method of torque-load limitation of a working vehicle to the extent that the disadvantages known in the prior art are avoided, and in particular the load reserve can be reduced and the effort for calculation and storage of the interpolation results is further reduced.

This object is achieved by the features of claim 1.

According to the invention, it is provided that, depending on the operating parameters detected, a value for a potential total energy of the working vehicle is calculated, taking into account the configuration of the working vehicle, and the unknown load value is determined from this information. Then the saved load-characteristics map can be adapted using this unknown load value, which is no longer unknown, taking into account the operating parameters, so that a much more accurate load value can be determined in particular as a function of the specific configuration of the working vehicle and may then be compared with the load-limit value from the load table. It is thus possible to significantly reduce the load reserve and to bring the working point of the working vehicle much closer to the load limit. Thus, according to the invention, the potential total energy of the working vehicle, in particular of a mobile crane and in particular its mathematical derivation according to the degrees of freedom of movement (boom angle) are determined in a computation unit. The energy thereby determined advantageously includes the inherent weights of the components of the working vehicle, the elastic energy due to deformation of these components and the load lifted. This is of particular advantage because tolerances and changes in these components are automatically taken into account in the calculation of the potential total energy and the attached load calculated therefrom. The reactive forces and/or torques can be measured in general by measuring the operating parameters of an actuator, which influences a component of the working vehicle. From the resulting equation, the computation unit determines the unknown load lifted. Another advantage may be seen in the fact that the calculation also supplies the current horizontal load position, taking into account the deformation of the boom, in addition to determining the load.

In a further embodiment of the invention, characteristic variables of the working vehicle and/or characteristic variables of its components are taken into account in calculating the total energy. Knowledge of a series of characteristic variables of this working vehicle is necessary for calculating the potential total energy of the working vehicle. These variables include, for example, the weights and the center of gravity position of components of the working vehicle, for example the geometric dimensions, weights and properties of components of a crane. These characteristic variables are not known with sufficient accuracy in advance due to manufacturing tolerances, renovations or add-ons as well as other variations (for example material properties) in the components used. The sensor system used for detecting the operating parameters, such as pressures, lengths and angles and the like, also have measurement uncertainties. All the deviations mentioned above depend on the model or even on the exemplar. To ensure the best possible utilization of a working vehicle (working near the load limit), while at the same time ensuring safe operation, calibration of the characteristic variables is therefore essential.

Therefore, in a further embodiment of the invention, the characteristic variables are determined experimentally. Alternatively or additionally, it is possible to provide for the characteristic variables to be correctable by means of preselectable variables and/or factors. To do so, a number of measurements using known loads are performed in typical states of the working vehicle. The characteristic variables are determined in the sense of a statistical estimation method and/or nominal values are corrected such that best possible correspondence with the measurements is achieved. This method may thus be used for fine tuning when there is little prior knowledge (for example in so-called retrofitting of an existing working vehicle) as well as when there is relatively detailed information about the nominal values (for example in the case of a new working vehicle). The requirement measurement effort depends inversely on the quantity and quality of the pre-existing knowledge.

An illustrated embodiment is described below.

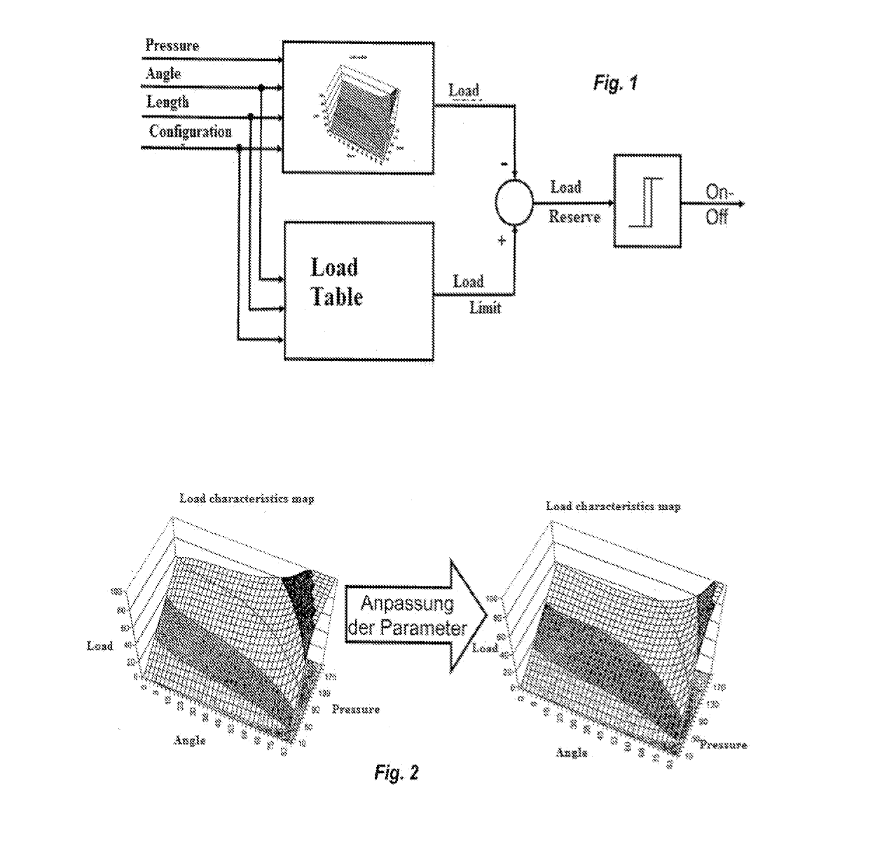

FIGS. 1 and 2 show, inasmuch as they show details, a device for performing the inventive measurement for torque-load limitation of a working vehicle. Like the device shown in FIG. 3, operating parameters such as pressure, angle, length, configuration and the like as well as a load-characteristics map and also a load table are supplied in the load characteristics in which one or more multidimensional characteristics maps are stored, the load characteristic map(s) saved there is/are adjusted in accordance with FIG. 2, taking into account the calculated potential total energy of the working vehicle and the unknown load determined therefrom, so that a significantly more accurate value is available for the load actually suspended from the working vehicle in comparison with the load values determined using the methods known from the prior art. This significantly more accurate load value may consequently be compared with the load-limit value, so that it is either possible to significantly minimize an existing load reserve, or under some circumstances, it may not be possible to provide any more load reserve under some circumstances. The comparison between the load value actually determined and the load-limit value that is also determined thus leads to a warning or a shutdown of the working vehicles, when the actual load value exceeds the allowed load-limit value as a function of the detected operating parameters.

1. A method of torque-load calculation of a working vehicle having a boom, in particular a mobile crane having a multipart boom or telescoping boom, preferably movable hydraulically, wherein a load value is determined from detected operating parameters of the working vehicle such as pressure, angle, length, configuration and the like from at least one multidimensional characteristics map and this load value is compared with a load-limit value determined as a function of the detected operating parameters, wherein when the actual load value exceeds the load-limit value, a warning is issued or operation of the working vehicle is necessarily interrupted, wherein a value for a potential total energy of the working vehicle is calculated as a function of the detected operating parameters, taking into account the configuration of the working vehicle, and the unknown load value is determined therefrom.

2. The method according to claim 1, wherein the characteristic values of the working vehicle or its components are taken into account in calculation of the total energy.

3. The method according to claim 2, wherein the characteristic values are determined experimentally.

4. The method according to claim 3, wherein the characteristic values are corrected using preselectable variables or factors.
